(19) United States
(12) Patent Application Publication
(10) Pub. No.: US 2024/0324044 A1
(43) Pub. Date: Sep. 26, 2024

(54) Methods, and Devices, of Estimating a Duration that a User Equipment, UE, is Unreachable Caused by a Coverage Hole in a Coverage Area of at Least one Access Node in a Telecommunication Network

(71) Applicant: Telefonaktiebolaget LM Ericsson (publ), Stockholm (SE)

(72) Inventors: Mehdi Abad, Aachen (DE); Refik Fatih Ustok, Istanbul (TR); Ahmet Cihat Baktir, Istanbul Küçükçekmece (TR); Elham Dehghan Biyar, Istanbul (TR); Jale Sadreddini, Istanbul (TR)

(21) Appl. No.: 18/578,041

(22) PCT Filed: Jul. 7, 2022
(86) PCT No.: PCT/EP2022/068987

§ 371 Date: Jan. 10, 2024

(30) Foreign Application Priority Data
Jul. 14, 2021 (TR) 2021011557

(51) Int. Cl. H04W 76/19; H04W 36/32

(52) U.S. Cl. CPC H04W 76/19; H04W 36/32

(57) ABSTRACT

A method of estimating a duration that a User Equipment, UE, is unreachable caused by a coverage hole in a coverage area of at least one access node in a telecommunication network, said method comprises the steps of determining that a connection between said UE and said telecommunication network is lost, determining that said loss of connection is due to said UE entering said coverage hole, estimating said duration of said UE in said coverage hole based on a coverage map comprising said coverage area as well as said coverage hole, and a location and/or time information of said UE in said coverage area.

### TECHNICAL FIELD

The present disclosure relates to coverage holes in a coverage area of at least one access node in a telecommunication network and, more specifically, to a method of estimating the duration of a User Equipment, UE, in such a coverage hole.

### BACKGROUND

In telecommunication networks, a User Equipment, UE, connects to the network over wireless links. To maintain the connectivity over error prone wireless links, in Long Term Evolution, LTE, and New Radio, NR, there are well defined mobility management functions that strive to ensure that the UE can be reached whenever possible.

The telecommunication network is responsible to maintain the “connected” state of the UE while various mobility events occur, such as the UE entering another cell's coverage. When the signal strength of a UE to its serving cell deteriorates to a point that packets cannot be reliably decoded, the telecommunication network may find a better candidate and hands over the connection to a neighbour cell.

Such mobility management decisions are realized by the help of a measurement framework, wherein the UE provides information on signal strength of serving and neighbour cells in dedicated reports to the network. A mobility function at the telecommunication network side uses this information to identify the best course of action to ensure that the connection to the UE is not lost.

However, not all handover, HO, actions are successful. It may be the case that the HO procedure results in a failure. For example, the connection to the serving cell becomes so poor and that the HO command from the network may not be received by the UE. In such cases a radio link failure, RLF, event occurs. In case of RLF, the UE tries to recover the connection by triggering an RRCReestablishment procedure. If it fails, the UE enters Idle mode and tries to establish a connection from a clean slate. As long as the UE is located in a cell with acceptable signal strength levels, eventually the UE recovers its connection to the network.

However, there are cases when the UE enters an area such that the signal strength of the serving cell becomes unreliable while the UE has not been able to find a better candidate in neighbour cells. In this scenario, since there is no alternative cell to HO the connection, the UE loses its connection to the network. Such areas are referred to as coverage holes. When a UE enters a coverage hole, the connection to the serving cells becomes unreliably weak while there is no neighbour cell with acceptable signal quality to HO the connection. A coverage hole is not limited to a certain geographical location. With the introduction of mm-Wave to 5G and even possibility of tera Hz into 6G, moving objects can potentially block the connection to a UE and create a moving coverage hole.

When a UE enters a coverage hole, first it experiences an RLF event. If it cannot recover from the RLF, e.g., RRCReestablishment procedure fails, after a while it enters an unreachable state at network side, i.e., Access and Mobility management Function, AMF. This state can be shared by other network functions by subscribing to “UE Reachability” notification. The UE may become unreachable for other reasons such as power saving mode or Mobile Initiated Connection Only, MICO, mode.

In case of power saving mode, the network configures the UE with extended Discontinuous Reception, eDRX, mode which has a relatively large value. The UE hence monitors the paging occasions over relatively large periods. For this reason, the UE becomes unreachable. In another case, when the UE successfully negotiates the MICO mode with the network, it does not monitor any downlink related activity and only connects to the network if it has data to transmit in the uplink or due to MICO mode configuration, e.g. expiration of a timer.

In both cases, the AMF can estimate the maximum time the UE will be unreachable because it has the knowledge about the configuration. Such information enables further optimization of the network procedures. The examples are extended to buffering by Session Management Function, SMF, for delay tolerant data or allowing an Application Function, AF, to store pending data that needs to be transmitted to the UE. Unfortunately, becoming unreachable due to a coverage hole does not fall within this category because the network cannot estimate for how long the UE remains unreachable.

Following the above, there is a need for developing a method for estimating the duration that a UE is unreachable caused by a coverage area of at least one access node in a telecommunication network.

### SUMMARY

It would be advantageous to obtain a method of estimating a duration that a User Equipment, UE, is unreachable caused by a coverage hole in a coverage area of at least one access node in a telecommunication network. It would also be advantageous to obtain corresponding devices and/or entities.

In a first aspect of the present disclosure, there is provided a method of estimating a duration that a User Equipment, UE, is unreachable caused by a coverage hole in a coverage area of at least one access node in a telecommunication network, said method comprises the steps of:
determining that a connection between said UE and said telecommunication network is lost;
determining that said loss of connection is due to said UE entering said coverage hole;
estimating said duration of said UE in said coverage hole based on:
   a coverage map comprising said coverage area as well as said coverage hole, and
   a location and/or time information of said UE in said coverage area.

The inventors have found that the use of a coverage map in combination with location and/or time information of the UE may aid in estimating the duration that a UE is unreachable caused by a coverage hole in the coverage area of at least one access node.

In an example, the coverage map is a visual, or digital, representation of the coverage area of the at least one access node. The coverage map may be generated by a network node by logging the location and signal strengths of a UE. Location information could, for example, be estimated by the network, for example using triangulation, or could be reported by the UE for example GNSS. The signal strength of a UE could be obtained by the UE reporting measurement results such as Reference Signal Received Power, RSRP and Reference Signal Received Quality, RSRQ. The coverage map could thus be construed based on the location and signal strength of one or more UEs over a period of time.

Following the above, the coverage map could contain so called coverage holes, i.e. areas in the coverage map in which no, or hardly any, UE is supposedly to have an active connection to the telecommunication network. This is explained in more detail with reference to FIG. 1.

The location and/or time information of the UE could represent the location and/or the time of the UE in the coverage map.

By combining the knowledge of the location and/or time of the UE in coverage map, and the coverage holes in the coverage map, a duration of the UE in a coverage hole may be estimated.

The examples of the methods in accordance with the present disclosure are performed by a network entity. A network entity is either a network node or a User Equipment. The network node could reside in the Radio Access Network but could also reside in the core network of the telecommunication network. In an example, the network entity is an access node, i.e. base station, like an eNodeB in a Long Term Evolution, LTE, based telecommunication network or a gNodeB in a New Radio, NR, based telecommunication network.

In an example, the method further comprises any of the steps of:
estimating said location and/or time information of said UE in said coverage area based on signal strength indicators;
receiving from a location server in said telecommunication network, said location and/or time information of said UE in said coverage area.

The signal strength indicators could be used to estimate a distance of a particular UE to a corresponding access node. The estimated distance could represent a radius to the access node. Multiple signal strength indicators could be used, from multiple access nodes, wherein multiple signal strength indicators could be used for triangulation purposes to more accurately determine the position of a particular UE in the coverage map.

Another option is that the location and/or time information is received from a location server in the telecommunication network. For example, the location server could be used to predict the UE unreachability duration in, for example, some indoor and outdoor areas before entering a coverage hole.

In order to expose this information to the telecommunication network as well as to the other applications, an approach leveraging the interfaces defined by 3GPP SEAL architecture may be utilized. The SEAL location management client and server can be utilized for this purpose. The SEAL architecture enables location management and it supports client location reporting and location data sharing between client and application. In a typical scenario, the Vertical Application Layer, VAL, client, i.e. application client in the UE, sends the location information, e.g. obtained through GPS, to the SEAL location management client through LM-C interface.

Then, this information may be forwarded to the SEAL location management server through LM-UU interface. Upon receiving the coverage hole duration information, this can be exposed to various endpoints such as:
3GPP Network functions, such as SMF, AMF, by sending this UE-specific coverage hole duration information through T8 interface, which supports the interactions between the SEAL location management server and the Service Capability Exposure Function, SCEF.
VAL servers through LM-S interface for further optimization throughout the environment, such as factory floor.
5G NW AAS through its south-bound interface connecting it to SEAL location management server.

In a further example, the method comprises the steps of:
creating said coverage map using received signal strength indicators obtained from a plurality of UE in said coverage area over time.

The signal strength indicators are, for example, Reference Signal Received Power, RSRP and Reference Signal Received Quality, RSRQ.

In another example, the method comprises the step of:
obtaining said location and/or time information of said UE in said coverage area over time,
and wherein said step of estimating comprises:
estimating said duration of said UE in said coverage hole based on differences in said obtained location and/or time information of said UE in said coverage area over time.

Based on the location and/or time information of the UE in said coverage are over time, a prediction could be made of the trajectory of that particular UE. For example, a linear prediction of the UE could be used for predicting how the UE moves over a particular area. Based on this prediction, it could be estimated when, and how long, the UE will reside in the coverage hole, and will thus not be reachable by the telecommunication network.

In an example, the prediction may is based on historical data. For example, the particular routes of a UE may be logged, wherein the logs may be used for establishing some sort of pattern, habit, or standardized trajectory, of the UE. The UE may, for example, traverse a particular route each day, each week or anything a like. For example, whenever a person is traveling to his/her work.

The above described information may be used for estimating the duration of the UE in the coverage hole.

In an example, the method further comprises the step of:
determining based on said location and/or time information of said UE in said coverage area over time, an expected set of location and/or time information of said UE in said coverage hole, and
estimating said duration of said UE in said coverage hole based on said determined expected set of location and/or time information.

The above described example reflects the concept that a particular UE may have recognizable patterns in that the UE travels from one location to another location at set moments in time.

In a further example, the step of estimating said duration of said UE comprises:
estimating, using a machine learning algorithm, said duration of said UE in said coverage hole.

In another example, the UE logs its location information, and sends the logged location information to the network to an improved trajectory estimation in the coverage hole area.

In a second aspect of the present disclosure, there is provided a method of exposing a duration that a User Equipment, UE, is unreachable caused by a coverage hole in a coverage map of at least one access node in a telecommunication network, said method comprising the steps of:
obtaining said estimated duration of said UE in said coverage hole;
transmitting, said estimated duration of said UE in said coverage hole to at least one network node in said telecommunication network.

The above described example is related to exposing the duration information to one or more network nodes such that those one or more network nodes are able to take adequate actions.

The obtaining step as disclosed above may be associated with any of the examples as provided above for obtaining the estimated duration of the UE in the coverage hole.

In a third aspect, there is provided a network entity arranged for operating in a telecommunication network and arranged for estimating a duration that a User Equipment, UE, is unreachable caused by a coverage hole in a coverage area of at least one access node in a telecommunication network, the network entity comprising:
process equipment arranged for determining that a connection between said UE and said telecommunication network is lost, and for determining that said loss of connection is due to said UE entering said coverage hole;
estimate equipment arranged for estimating said duration of said UE in said coverage hole based on:
   a coverage map comprising said coverage area as well as said coverage hole, and
   a location and/or time information of said UE in said coverage area.

The benefits and advantages as discussed with respect to the first aspect of the present disclosure, being the method, are also applicable to the third aspect of the present disclosure, being the network entity.

In an example, the estimate equipment is further arranged for estimating said location and/or time information of said UE in said coverage area based on signal strength indicators,
and wherein said network entity further comprises receive equipment arranged for receiving from a location server in said telecommunication network, said location and/or time information of said UE in said coverage area.

In another example, said network entity comprises:
create equipment arranged for creating said coverage map using received signal strength indicators obtained from a plurality of UE in said coverage area over time.

In yet another example, the said network entity further comprises:
obtain equipment arranged for obtaining said location and/or time information of said UE in said coverage area over time,
and wherein said estimate equipment is further arranged for estimating said duration of said UE in said coverage hole based on differences in said obtained location and/or time information of said UE in said coverage area over time.

In a further example, the process equipment is further arranged for determining based on said location and/or time information of said UE in said coverage area over time, a trajectory of said UE through said coverage hole, and wherein said estimate equipment is arranged for estimating said duration of said UE in said coverage hole based on said determined trajectory.

In an example, the estimate equipment is further arranged for estimating, using a machine learning algorithm, said duration of said UE in said coverage hole.

In a fourth aspect, there is provided a network entity arranged for exposing a duration that a User Equipment, UE, is unreachable caused by a coverage hole in a coverage area of at least one access node in a telecommunication network, wherein said network entity comprises:
obtain equipment arranged for obtaining said estimated duration of said UE in said coverage hole;
transmit equipment arranged for transmitting said estimated duration of said UE in said coverage hole to at least one network node in said telecommunication network.

In a fifth aspect, there is provided a computer program product comprising a computer readable medium having instructions stored thereon which, when executed by a network entity, cause said network entity to implement a method in accordance with any of the examples as provided above.

These and other aspects of the invention will be apparent from and elucidated with reference to the embodiment(s) described hereinafter.

### BRIEF DESCRIPTION OF THE DRAWINGS

FIG. 1 discloses a coverage map in accordance with the present disclosure;

FIG. 2 discloses a coverage map showing a trajectory of a particular User Equipment UE, in accordance with the present disclosure;

FIG. 3 discloses an example of a flow chart in accordance with the present disclosure

FIG. 4 discloses an example of a flow chart in accordance with the present disclosure;

FIG. 5 discloses an example of a coverage map showing two possible trajectories of a particular UE, in accordance with the present disclosure;

FIG. 6 discloses a signalling diagram between entities of the communication network, in accordance with the present disclosure.

### DETAILED DESCRIPTION

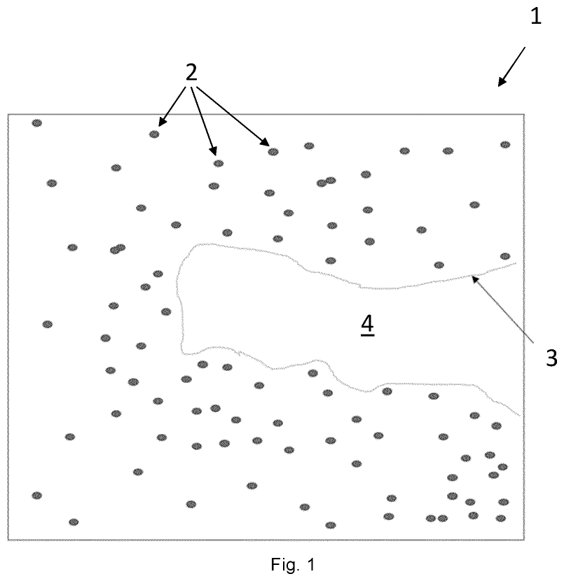

FIG. 1 discloses a coverage map in accordance with the present disclosure.

An entity on the network side, for example an access node in the Radio Access Network, RAN, like the gNB, estimates the duration of the coverage hole based on a coverage map, and location/time information of the UE. The coverage map could be constructed when the network entity logs location and signal strength of the UE over time. The location information can be estimated by the network, for example by triangulation, or reported by the UE, for example by utilizing the GNSS. The signal strength of the UE is obtained by the UE reporting measurement results such as RSRP/RSRQ in Long Term Evolution, LTE, and New Radio, NR. An example is depicted in FIG. 1.

FIG. 1 thus discloses the coverage map 1. The coverage map comprises a lot of so-called measurements 2, wherein a location of a UE that had a connection to the network, is determined. Based on a plurality of measurements, it may appear that a particular hole is present as indicated with reference numeral 4. The hole may also be indicated by the border as indicated with reference numeral 3.

The coverage map 1 is thus constructed based on the location and signal strength of the UE over a period of a time. Each dot 2 corresponds to location (X, Y) and may include signal strength. X and Y may be the horizontal and vertical coordinates of the UE, for example as measured from a reference point, and signal strength may depend on the type of the coverage map. For example, if its RSRP coverage map, then the signal strength corresponds to the RSRP value.

The coverage hole 4 may correspond to the area in the coverage map where there is no associated signal strength measured. The network may already have constructed the map based on the information obtained from multiple UEs and stored it in a repository. The network could periodically obtain (location, signal strength, timestamp) information and combine this information with the coverage map to estimate the duration of stay in the coverage hole.

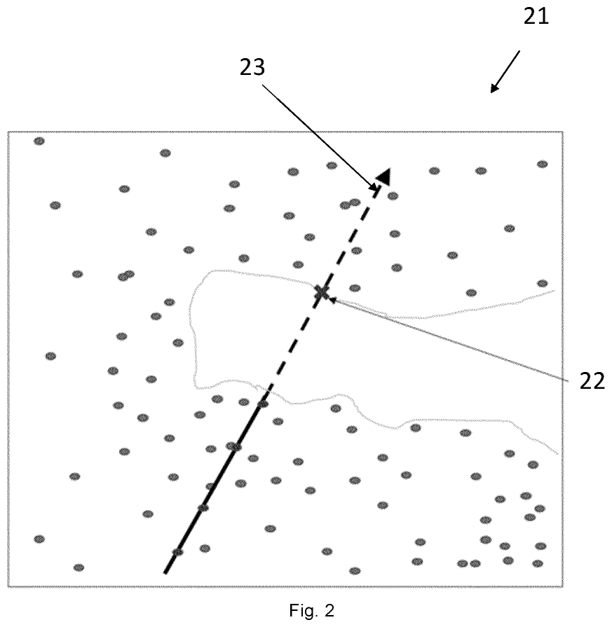

In one example it is assumed that the UE moves in a straight line 23 which corresponds to a highway. An example trajectory 23 of the UE is depicted in FIG. 2, having reference numeral 21.

Based on the obtained trajectory (X1, Y1), (X2, Y2), . . . , (Xn, Yn), the network may calculate the average velocity of the UE. It is noted that (Xn, Yn) may refer to the last point in the trajectory before the UE enters the coverage hole.

In one example, the network may use the trajectory information to calculate the average speed, i.e.,

$$V = \frac{\sqrt[2]{{( X n - X 1 )}^{2} + {( Y n - Y 1 )}^{2}}}{t} ,$$

where t is the time it took for the UE to go from (X1, Y1) to (Xn, Yn).

In a further example, the network considers the last two points in the trajectory to calculates the average speed, i.e.,

$$V = \frac{\sqrt[2]{{( X n - X ( n - 1 ) )}^{2} + {( Y n - Y ( n - 1 ) )}^{2}}}{t}$$

where t is the time it took for the UE to go from (X(n−1), Y(n−1)) to (Xn, Yn).

In another example, the network considers the last M points to calculate the average speed, i.e.,

$$V = \frac{\sqrt[2]{{( X n - X ( n - M ) )}^{2} + {( Y n - Y ( n - M ) )}^{2}}}{t}$$

where t is the time it took for the UE to go from (X(n−M), Y(n−M)) to (Xn, Yn).

Then, based on the trajectory of the UE and the coverage map, the estimated location where the UE exits the coverage hole may be calculated 23. The trajectory of the UE inside the coverage hole may be modeled with a linear equation in the form Y=ax+b.

Trajectory of the UE before entering the coverage hole can be used to find a and b, i.e.,

$$Y = \frac{Y n - Y ( n - 1 )}{X n - X ( n - 1 )} ( X - X n ) + Y n .$$

Then the location of the exit from coverage hole (i.e., (Xe, Ye)) may be calculated by crossing the line and the border of a coverage hole. Then estimated duration of the stay in coverage hole is calculated as,

$$EstimatedDuration = \frac{\sqrt[2]{{( X e - X n )}^{2} + {( Y e - Y n )}^{2}}}{v} .$$

The (estimated) exit of the UE from the coverage hole is depicted with reference numeral 22.

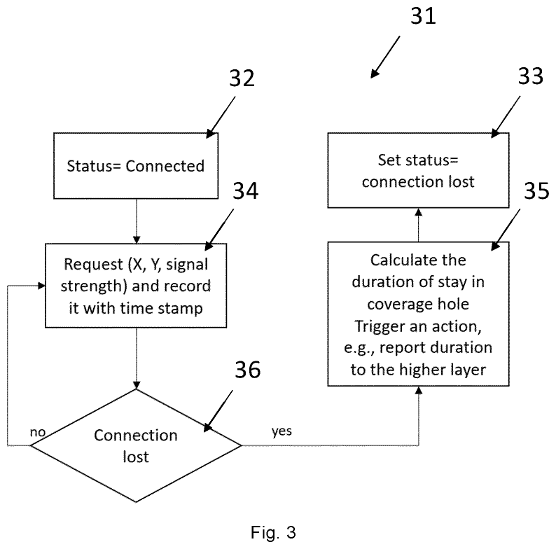

A flow chart of procedures and actions 31 starting from connected state is depicted in FIG. 3.

The flow chart 31 of FIG. 3 resembles the method in accordance with the present disclosure.

First, a particular UE could be connected 32 to the network via a base station in the RAN. During its connected time, a base station may request the location and/or signal strength of the UE, and may record received locations and/or signal strengths with a time stamp. This is indicated with reference numeral 34.

As long as the connection is not lost 36, the base station may keep requesting the location and/or signal strengths of the UE and may keep recording it with a time stamp 34. This process may continue until the connection is lost 36.

Then, the base station, or any other entity in the network, may determine the duration of stay of the UE in the coverage hole 35, and may set the status of the UE to connection lost 33.

That is, FIG. 3 discloses a method of estimating a duration that a User Equipment, UE, is unreachable caused by a coverage hole in a coverage area of at least one access node in a telecommunication network.

The method comprises the steps of determining that a connection between said UE and said telecommunication network is lost 36. Determining that said loss of connection is due to said UE entering said coverage hole 35 and estimating said duration of said UE in said coverage hole based on a coverage map comprising said coverage area as well as said coverage hole, and a location and/or time information of said UE in said coverage area.

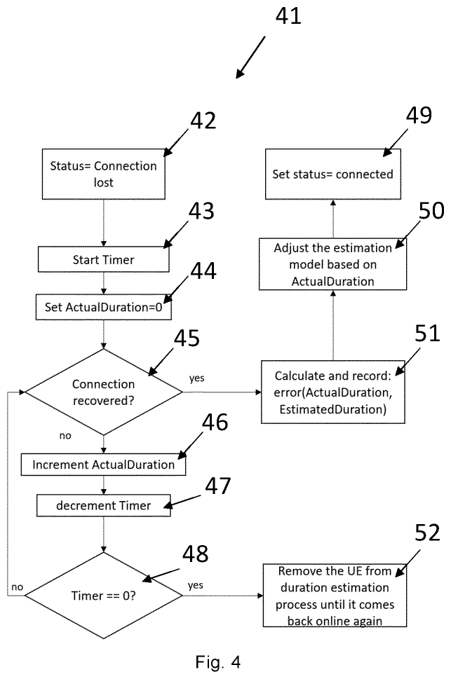

A flow chart of procedures and actions 41 after entering the connection lost state is depicted in FIG. 4. That is, the UE is in a connection lost 42 state.

When UE recovers from the coverage hole, the network calculates the actual time the UE had spent in the coverage hole, i.e., ActualDuration 44 in flow chart by starting a timer 43. Hence, it may also calculate the error for that prediction as ActualDuration-EstimatedDuration once the connection is recovered 45.

The ActualDuration time is incremented 46 and the Timer is decremented 47 until the connection is recovered 45 or until the Timer reaches a zero value 48, wherein it may be decided that the UE is to be removed from duration estimation process until it becomes back online again 52. The Timer may thus be considered some sort of timeout principle for not endlessly keeping track of unreachability of the UE during its presence in a coverage hole, which may result in a non-finale state of the UE in the telecommunication network.

The predictor is able to calculate and record an average error of the model based on the calculated errors.

In one example the AverageError=Σₜ error(t)

In another example the AverageError=(1−αAverageError+α*error

In other example the AverageError is a moving average.

Hence, the EstimatedDuration can be compensated by adding an AverageError 50.

Finally, the status of the UE may be set to connected 49.

In another example, the estimation is improved by compensating for the distance. The UE in the coverage hole may have a different trajectory than the assumed linear one. Based on the error, the traveled distance can be compensated by adding an offset to the assumed traveled distance.

$$ActualDuration = \frac{D + Δ D}{V}$$

$$EstimatedDuration = \frac{D}{V}$$

Where D is the distance and AD is the distance offset. Hence, ΔD=(ActualDuration−EstimatedDuration)V can be used as an offset to make corrections to the estimated duration.

The corrections may differ based on the time of the day or the specific day of the week etc. and so corrections are recorded with time intervals. For example, the correction is only made during the day, but no corrections are applied during the night.

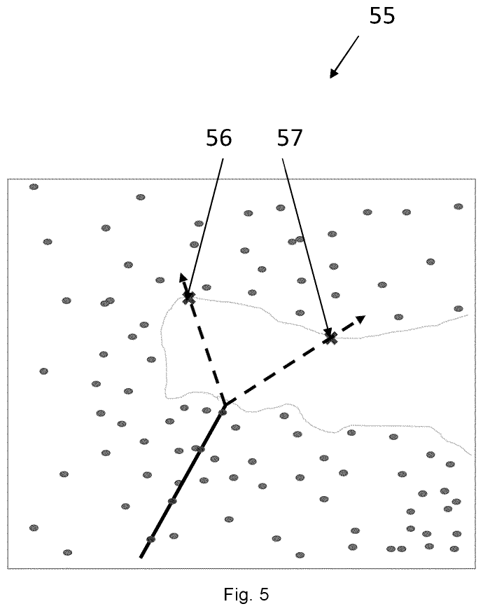

In another example 55, there may be multiple possible trajectories for the UE to pass through the coverage hole as depicted in FIG. 5, i.e. having reference numerals 56 and 57.

Based on the history of the reported locations upon exiting the coverage hole, the network may know that there are multiple potential exit points. In this case, the network may calculate two estimations and reports them to the higher layers. In one option based on the history of the recorded estimations, the network may calculate probabilities corresponding to the estimated durations. For example, the network record N1, N2 as the number of times the UEs traverse through path 1 and path 2 respectively. Then calculates the probabilities of passing through path1 as

$$\frac{N 1}{N 1 + N 2}$$

and path2 as

$$\frac{N 2}{N 1 + N 2} .$$

In another example, the UE identities are also recorded. Based on the record, the network can identify returning UEs that frequently pass through the coverage hole and calculate the probabilities for individual UEs.

In another option, machine learning methods can be used to estimate the duration of stay in coverage. The network constructs a dataset based on the collected locations, signal strength and calculated ActualDuration (explained above).

In a further example, a single data point in the dataset is of the form (features=(X_n, Y_n, v), label: ActualDuration)., where X_n, Y_n is the last location of the UE before entering the coverage hole and v is the average velocity calculated using two or more points in the trajectory of the UE.

In yet a further example, a single data point in the dataset is of the form (features=(X_n, Y_n, vn, X_(n−1), Y_(n−1), v_(n−1)), label: ActualDuration)., where the whole trajectory is considered as features and velocity is calculated between any two consecutive location, i.e.,

$$v\_n = \frac{\sqrt[2]{{( Xn - X ( n - 1 ) )}^{2} + {( Y n - Y ( n - 1 ) )}^{2}}}{f\_n} ,$$

where t_n is the time it took to UE to move from (X(n−1), Y(n−1)) to (Xn, Yn).

Artificial Neural Networks, ANN's, may be used as a machine learning tool. In the simplest form, the ANN may have no hidden layer, and hence it may become a linear regression model.

The related data including the duration prediction or estimation may be relayed to the network, so that any signaling when UE is not reachable can be minimized. Additionally, an improved resource allocation and planning can be realized with an efficient configuration in the core network, for example AMF, SMF, UPF. For example, the duration information can be sent to the UPF through Service Capability Exposure Function, SCEF, and SMF for optimally configuring the buffers until the UE becomes reachable again.

In order to expose this information to the network as well as to the other applications, this document proposes an approach leveraging the interfaces defined by 3GPP SEAL architecture. The SEAL location management client and server can be utilized for this purpose.

The SEAL architecture enables location management and it supports client location reporting and location data sharing between client and application. In a typical scenario, the VAL client, i.e., application client in the UE, may send the location information, e.g., obtained through GPS, to the SEAL location management client through LM-C interface. Then, this information is forwarded to the SEAL location management server through LM-UU interface. Upon receiving the coverage hole duration information, this can be exposed to various endpoints such as
3GPP Network functions, such as SMF, AMF, by sending this UE-specific coverage hole duration information through T8 interface, which supports the interactions between the SEAL location management server and the Service Capability Exposure Function, SCEF.
VAL servers through LM-S interface for further optimization throughout the environment, such as factory floor.
5G NW AAS through its south-bound interface connecting it to SEAL location management server

In case GPS does not work accurately, especially for indoor scenarios, another approach is to retrieve the location information from the network through 3GPP defined interfaces. The SEAL location management server may access Location Services, LCS, from a Gateway Mobile Location Centre, GMLC.

Upon receiving the location request for a UE, The GMLC may forward this to a serving AMF through the Namf interface after performing authorization of SEAL server and verifying the target UE privacy. Then, Location Management Function, LMF, may receive this request through NImf interface and report the UE location backwards to the SEAL server and monitoring agent after determining the positioning method based on UE capabilities.

However, none of these approaches are designed to carry information about duration through the standard interfaces. The location information report provided by SEAL location management server to SCEF, VAL Server or 5G NW AAS includes information as follows:
Set of identities of the UEs;
Triggering event;
Location information.

Therefore, in an example a field to this data structure is added to store the “duration” and “confidence level” in the location information report, which represents the expected duration of UE's stay in a location with a confidence level of the inference. Triggering event may be the identity of the event that triggered the sending of the report. In case of coverage hole, the triggering event may specify that the report is sent upon a coverage hole prediction. This set of information can be forwarded to the SCEF in the network system so that necessary optimizations are carried out. For example, if the duration of unreachable state is known, the UPF may accordingly manipulate the buffering operations for the packets.

Beside of these benefits, the SEAL server may expose the coverage hole duration information to the requesting application servers. This opportunity may enable a further optimization in application level. For example, while an application server is responsible for sensor configuration, another application server may be responsible of updating the software/firmware of the mobile devices. The coverage hole duration information may then be reported to these separate application servers and they are able to improve their own task planning, such as scheduling the update for minimizing the downtime.

As a feasible variant of the proposed solution to convey information about the predicted duration of being not reachable, another option is an approach that does not require a modification in SEAL architecture: configuration management service in SEAL.

Since this approach may allow data transmission from VAL server to SEAL server, which may not be available in the location services, it is practically advantageous for the scenario where the Machine Learning model runs at the application server.

After the inference is made for a particular UE after obtaining the necessary data at the VAL server, this information can be transmitted to the configuration management server (i.e., SEAL server) through CM-S interface. The data carried over this interface may also be defined. Therefore, a new endpoint may be defined to transfer the related information over this interface, including the UE identification, coverage hole location and estimated duration.

After aggregating this information at the configuration management server, it may be forwarded to the 3GPP system for further planning and network management operations. However, even though the T8 interface may be defined for the communication between 3GPP system and location management server, it may not available for the configuration management server. Even though the duration and location information may be exposed to multiple VAL servers, i.e., application servers, for enhancing the degree of automation and optimization, the configuration management server may not have a standardized interface with the 3GPP network system.

Therefore, in an example, an interface is defined and implemented between 3GGP network and configuration management server for secure and feasible data transmission.

An alternative approach instead of defining an interface between 3GPP system and configuration management server is to combine the functionalities provided by both solution methodologies. Since SEAL architecture enables the intercommunication between SEAL servers of distinct services through SEAL-X reference point, the location and duration information aggregated at the configuration management server can be fed into location management server. Then, the location management server can utilize T8 interface for relaying this information into the core network.

So that, the advantages provided by both location and configuration management services can be utilized in a single approach. The VAL server-SEAL server communication of configuration management service and having interface between 3GPP system and location management server can be utilized together for the data transmission throughout the system.

If the Machine Learning, ML, model is run at the application server for predicting the duration, this information can be transmitted to the UE, i.e., VAL client, at the application layer. Upon receiving this information, the aforementioned sequence of traffic may be realized to expose this information to multiple VAL servers and 3GPP network components.

It is presented that the prediction is realized by either the VAL client or VAL server. After determining the necessary information about the coverage hole and duration prediction, this information may be relayed to SCEF for further exposure in the network.

After obtaining coverage hole related information at the SCEF, this information may be forwarded to the corresponding network functions to optimize the operations within the network. Two different use cases with necessary message exchanges among the entities through reference points and interfaces are depicted may be possible.

The SCEF, after retrieving the location and duration information through T8, may send this information to the SMF through N29 reference point. After that, according to the first use case scenario, the SMF may forward this information to the UPF so that the buffer at UPF can be configured, including the timer and amount of downlink data to be buffered according to the coverage hole duration.

Then, the UPF may send an acknowledge to inform that necessary configurations are made. For example, if the duration informed to the SMF is less than X minutes, the SMF sends “buffering on” command over N4 Session Modification Request. Conversely if the duration is more than X minutes and the configuration at UPF is “buffering on” the SMF sends N4 Session Modification Request to set “buffering off”. In another embodiment, the SMF starts Protocol Data Unit, PDU, Session Release procedures if duration>X minutes.

Other use case scenario focuses on the access node release operations for efficient resource management. In order to realize this case, the SMF may send the location and duration information to AMF through N11 reference point. When the UE becomes unreachable, the AMF may use the information it retrieves from SMF in order to configure the PDU session for example if the AMF receives the information that UE will be in coverage hole for more than 10 minutes then the AMF starts “AN release” procedure.

This procedure may be used to release the logical NG-AP signaling connection for the UE between the (R)AN and the AMF and the associated N3 User Plane connections, and (R)AN signaling connection between the UE and the (R)AN and the associated (R)AN resources.

In an example, the present disclosure may be exposed to I4.0 capable assets through a sub-model within 5G UE AAS and 5G Network AAS. One of the extensions to the solution is that SEAL Location Management Client, LMC, exposes the predicted coverage hole duration to 5G UE AAS via its southbound interface or SEAL Location Management Client sends this information to the SEAL Location Management Server which exposes the coverage hole duration to the 5G Network AAS via its southbound interface.

This information may then be utilized by I4.0 Factory system AAS through northbound interfaces of 5G UE AAS and 5G NW AAS for better planning, e.g. scheduling devices based on coverage hole prediction for system updates, configuration etc. The interaction between the 5G UE AAS/5G NW AAS and I4.0 Factory System AAS is realized with a Message Queuing Telemetry Transport, MQTT, broker.

To realize this extension, the predicted coverage duration may be covered in a sub-model of both 5G UE AAS and 5G NW AAS. We define the coverage holes sub-model as follows:

TABLE 1

| | | | Modelling |
|---|---|---|---|
| | | | Rule |
| Short ID/ | | Data | M—Mandatory |
| Name | Description | Type | O—Optional |
| UE ID | The ID of the reporting VAL UEs | String | M |
| Coverage | The Coverage hole Location | String | M |
| hole | information of the reporting VAL | | |
| Location | UEs | | |
| Coverage | The Coverage hole Location | String | M |
| hole | information of the reporting VAL | | |
| Duration | UEs | | |

This submodel in 5G UE AAS may include the information of the reporting UE, however the submodel in the 5G NW AAS includes the information of the all reporting VAL UEs.

In another alternative, intra network signaling may be used to inform a network node about the duration information. This case may assume that there is machine learning capability at UE side.

A UE in RRC connected state may be configured by the gNB to perform measurements and reports them to the gNB. Specifically, the gNB configures the UE to detect cells in a given frequency and measure the signal strength of them including the service cell. The configuration also sets conditions for the UE on what/how to report the measurements results. The trigger to report is either periodic or event based. An example of events is “Event A2: Serving becomes worse than absolute threshold”. When a report is triggered UE sends the measurement results in MeasResults IE. In this disclosure, the information regarding the duration and occurrence of the coverage hole is included in measurement reports and sent to the gNB. For example, the information related to the coverage hole can be included in the MeasResultServMO field in MeasResults IE.

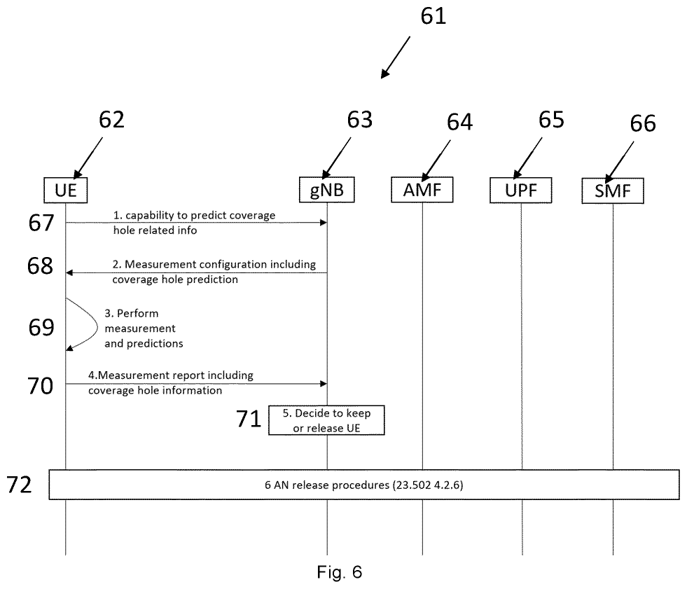

FIG. 6 shows a flow chart 61 of a UE indicating the capability to predict coverage hole related information.

The UE is indicated with reference numeral 62. The gNB is indicated with reference numeral 63. The AMF is indicated with reference numeral 64. The UPF is indicated with reference numeral 65 and the SMF is indicated with reference numeral 66.

The gNB 63 when receiving this information 67 can take further actions with this information. For example, if the UE 62 indicates that it will stay in the coverage hole for indefinite amount of time then the gNB can start “AN release” procedures.

The UE 62 informs 67 the network about its capability to perform predictions regarding the duration of a coverage hole

The network configures 68 the UE 62 with measurements including coverage hole prediction. In an example, the network configures the UE with a prediction model.

The UE 62 performs 69 measurements and predictions regarding the coverage hole duration.

When the criteria as set by the network (e.g., A2) triggers the measurement report, the UE may send 70 a measurement report to the network and includes information related to the duration of the coverage hole.

The gNB 63 inspects 71 the duration. In this example the UE sends “indefinite” value for duration being in the coverage hole. In this case, the gNB triggers the “AN release” procedure 72.

The present disclosure provides for several advantages over the prior art.

Signaling: The AMF may send multiple paging messages to the UE before it realizes that the UE is unreachable. Providing the AMF with a predicted duration of unreachability due to a coverage hole potentially reduces the paging number. For example, the AMF receives the information that the UE will be out of coverage for T seconds. It can trust the information and immediately set the state of the UE to unreachable or send a single paging message. If there is no response from the UE, then the UE's state can be set to unreachable. In other words, the number of paging messages that is sent to the UE can be minimized.

Deregistration: When the UE state changes to unreachable, the AMF does not know for how long the UE remains unreachable. Thus, it cannot initiate the deregistration process and start a deregistration timer with relatively large value. This value can be optimized based on the information on the predicted duration of the UE in a coverage hole. Hence, AMF can decide to delete or keep the UE context.

Enhancing subscription to the UE reachability state: An AF may request a one-time “UE Reachability” notification when it wants to send data to a UE, which is using a power saving function. The UE using a power saving function has relatively large eDRX values and the unreachability is due to this. However, since it is expected that the UE will be reachable almost surely, the AF can wait for sending the intended data to the UE in the future. However, when the UE is unreachable due to a coverage hole, it is not clear when it will be reachable again, and hence the AF may discard the pending data that is buffered to be sent to the UE. When the duration of staying in the coverage hole is provided, the AF may subscribe to the UE reachability notification based on the estimated duration available at AMF.

High latency communication is supported by extended buffering of downlink data in the UPF or SMF when a UE is using power saving functions in Connection Management (CM)-IDLE state and the UE is not reachable. Based on the setting of power saving function, the AMF provides Estimated Maximum Wait Time to e.g., SMF. Based on this information, for example SMF can determine the extended buffering time. When the UE enters a coverage hole, it is not known when it will be reachable again. Hence, in this case to avoid unnecessary resource utilization the extended buffering is not used. However, providing the duration of staying in coverage hole enables extended buffering depending on the estimated/predicted duration provided to the SMF. It should be noted that, the duration may be directly made available to the any other network function via the reference points and interfaces specified by 3GPP.

Further advantages may be related to application level optimizations.

The present disclosure is capable of providing the duration of unreachability due to the coverage hole to any applications that needs to connect to the UE. The example relates to the industrial UEs implemented on robots that perform specific jobs and automated guided vehicles, AGVs, which needs to go from one point to another in a smart logistics use-case. If another application, e.g., control application, needs the UE to be connected to the network in order to do a certain job, for example modifying the task, steering to another location, the application can plan the execution of the task based on the exposed predicted/estimated duration of unreachability. Exposing the duration information can also be beneficial for other UEs in the environment to organize and schedule the collaborative tasks concerning the continuity of the processes.

The predicted/estimated duration of unreachability can be integrated to model representation of an asset in AAS for a more accurate description of the physical asset in its digital representation.

Performance updates and fine-tuning to accommodate network expansion must be resolved in the field of interest. This is typically achieved with Firmware Over The Air, FOTA, updates which enables the device makers to deliver the wireless update for their devices. Exposing the UE's predicted coverage hole duration from network to FOTA server can enable better planning of the network utilization. For example, the UEs that are expected to be in the coverage hole for a specific time duration will not be scheduled for FOTA updates during that predicted time-interval.

It should be noted that the above-mentioned examples illustrate rather than limit the idea, and that those skilled in the art will be able to design many alternative examples without departing from the scope of the appended claims. The word “comprising” does not exclude the presence of elements or steps other than those listed in a claim, “a” or “an” does not exclude a plurality, and a single processor or other unit may fulfil the functions of several units recited in the claims.

Any reference signs in the claims shall not be construed so as to limit their scope.

1-15. (canceled)

16. A method for estimating a duration when a User Equipment (UE) is unreachable caused by a coverage hole in a coverage area of at least one access node in a telecommunication network, the method comprising:
determining that a connection between the UE and the telecommunication network is lost;
determining that the loss of connection is due to the UE entering the coverage hole; and
estimating the duration of the UE in the coverage hole based on:
a coverage map comprising the coverage area and the coverage hole, and
any one or more of a location information or a time information of the UE in the coverage area.

17. The method in accordance with claim 16, further comprising:
estimating the any one or more of the location information or the time information of the UE in the coverage area based on signal strength indicators;
receiving, from a location server in the telecommunication network, the any one or more of the location information or the time information of the UE in the coverage area.

18. The method in accordance with claim 16, further comprising:
creating the coverage map using the signal strength indicators obtained from a plurality of UE in the coverage area over time.

19. The method in accordance with claim 16, further comprising:
obtaining the any one or more of the location information or the time information of the UE in the coverage area over time; and
estimating the duration of the UE in the coverage hole based on differences in the obtained any one or more of the location information or the time information of the UE in the coverage area over time.

20. The method in accordance with claim 19, further comprising:
determining, based on the any one or more of the location information or the time information of the UE in the coverage area over time, an expected set of any one or more of the location information or the time information of the UE in the coverage hole; and
estimating the duration of the UE in the coverage hole based on the determined expected set of any one or more of the location information or the time information.

21. The method in accordance with claim 16, wherein the step of estimating the duration of the UE comprises:
estimating, using a machine learning algorithm, the duration of the UE in the coverage hole.

22. A method for exposing a duration when a User Equipment (UE) is unreachable caused by a coverage hole in a coverage area of at least one access node in a telecommunication network, the method comprising:
obtaining an estimated duration of the UE in the coverage hole; and
transmitting the estimated duration of the UE in the coverage hole to at least one network node in the telecommunication network.

23. A network entity arranged for operating in a telecommunication network and arranged for estimating a duration when a User Equipment (UE) is unreachable caused by a coverage hole in a coverage area of at least one access node in a telecommunication network, configured to:
determine that a connection between the UE and the telecommunication network is lost;
determine that the loss of connection is due to the UE entering the coverage hole; and
estimate the duration of the UE in the coverage hole based on:
a coverage map comprising the coverage area and the coverage hole, and
any one or more of a location information or a time information of the UE in the coverage area.

24. The network entity in accordance with claim 23, further configured to:
estimate the any one or more of the location information or the time information of the UE in the coverage area based on signal strength indicators; and
receive, from a location server in the telecommunication network, the any one or more of the location information or the time information of the UE in the coverage area.

25. The network entity in accordance with claim 23, further configured to:
create the coverage map using the signal strength indicators obtained from a plurality of UE in the coverage area over time.

26. The network entity in accordance with claim 23, further configured to:
obtain the any one or more of the location information or the time information of the UE in the coverage area over time; and
estimate the duration of the UE in the coverage hole based on differences in the obtained any one or more of the location information or the time information of the UE in the coverage area over time.

27. The network entity in accordance with claim 26, further configured to:
determine, based on the any one or more of the location information or the time information of the UE in the coverage area over time, an expected set of any one or more of the location information or the time information of the UE in the coverage hole; and
estimate the duration of the UE in the coverage hole based on the determined expected set of any one or more of the location information or the time information.

28. The network entity in accordance with claim 23, further configured to:
estimating, using a machine learning algorithm, the duration of the UE in the coverage hole.

29. A network entity for exposing a duration when a User Equipment (UE) is unreachable caused by a coverage hole in a coverage area of at least one access node in a telecommunication network, configured to:
obtain an estimated duration of the UE in the coverage hole; and
transmit the estimated duration of the UE in the coverage hole to at least one network node in the telecommunication network.
